(19) United States
(12) Patent Application Publication
(10) Pub. No.: US 2025/0107626 A1
(43) Pub. Date: Apr. 3, 2025

(54) MODULAR SQUAB CUSHION, AND SEAT ASSEMBLY COMPRISING SUCH A CUSHION

(71) Applicant: FAURECIA Sièges d'Automobile, NANTERRE (FR)

(72) Inventors: Didier DURIEZ, LE PLESSIS-PÂTÉ (FR); Marine MICHAUD, PARIS (FR); Thomas DAGONET, VERSAILLES (FR)

(21) Appl. No.: 18/899,750

(22) Filed: Sep. 27, 2024

(30) Foreign Application Priority Data
Sep. 29, 2023 (FR) 2310419

(51) Int. Cl. A47C 7/14; A47C 7/24; B60N 2/70; B60N 2/72

(52) U.S. Cl. CPC A47C 7/14; A47C 7/24; B60N 2/7005; B60N 2/72

(57) ABSTRACT

The present disclosure relates to a modular squab cushion, configured to be attached to a seat structure having a squab structure comprising two lateral flanges spaced apart by a front transverse tube and a rear transverse tube,
the modular squab cushion comprising, in the assembled state:
   a support,
   a padding resting on an upper surface of the support,
   a covering which covers the padding,
and wherein the mechanical interface system comprises:
   a rear mechanical interface on a rear portion of the base, comprising a first open housing, configured to house the rear tube, in a manner mechanically lockable by a locking system,
   a front mechanical interface on a front part of the support, comprising a second open housing, configured to house the front tube pivotably around the front tube.

### PRIORITY CLAIM

This application claims priority to French Patent Application No. FR2310419, filed Sep. 29, 2023, which is expressly incorporated by reference herein.

### BACKGROUND

The present disclosure relates the field of vehicle seats.

### SUMMARY

According to the present disclosure, a modular squab cushion, configured to be attached to a squab structure having a squab structure comprising two lateral flanges spaced apart by a front transverse tube and a rear transverse tube, the modular squab cushion comprising, in the assembled state:
a support forming a base comprising a mechanical interface system for attachment to the squab structure,
a padding resting on an upper surface of the support, and optionally
a covering which covers the padding,
and wherein the mechanical interface system comprises:
a rear mechanical interface, on a rear portion of the support, comprising a first, open housing, configured to accommodate the rear tube in a mechanically lockable manner by a locking system, in particular of the rear mechanical interface and/or external to the rear mechanical interface, or even external to the modular squab cushion
a front mechanical interface on a front part of the support, comprising a second open housing, configured to house the front tube, pivotably around the front tube, and wherein the mechanical interface system is configured to allow the attachment of the modular squab cushion by the following steps:
/A2/ placing the front mechanical interface opposite the front tube and inserting the front tube into the second housing, and
/B2/ pivoting the trim support around the front tube fitted into the second housing of the front mechanical interface until the rear tube is inserted into the first housing of the rear mechanical interface and mechanically locking the rear tube in the first housing via the locking system.

The features disclosed in the following paragraphs can optionally be implemented independently of one another or in combination with one another:
The first housing and/or the second housing are U-shaped housings;
the second, front housing opens out towards the front of the trim support, while the first housing opens out towards the underside of the trim support;
the first housing comprises a first insertion direction D1 for the rear tube and the second housing comprises a second insertion direction D2 for the front tube, the first insertion direction D1 and the second insertion direction D2 being inclined to one another at an angle of between 25° and 135°, for example between 45° and 90°;
the locking system of the rear mechanical interface is resiliently deformable, configured to allow resilient locking so that the locking of the rear tube in the first housing is obtained, at the end of stroke during pivoting carried out in step/B/of the modular cushion about the front tube, by resilient deformation of the locking system of the rear mechanical interface, preferably the first housing comprising a groove entrance of smaller dimension than the section of the rear tube, and a central portion housing the rear tube in locking position adjusted to the section of the rear tube;
the support is a plastic element obtained by injection molding, and wherein preferably the front and rear mechanical interfaces are obtained via the material from the support, typically during the molding of the support and wherein the single-piece plastic element extends
   from a front cross-member to a rear cross-member of the plastic element along a longitudinal direction X of the squab and,
   from a first longitudinal member to a second longitudinal member, along a transverse direction Y of the squab;

According to the present disclosure a seat assembly comprising a modular squab cushion according to the present disclosure and a squab structure comprising two lateral flanges braced by a rear tube and a front tube wherein, the modular squab cushion comprising, in the assembled state:
the support,
the padding resting on an upper surface of the support,
the covering the padding
and wherein the mechanical interface system is configured to allow the attachment of the modular squab cushion by the following steps:
/A2/ placing the front mechanical interface opposite the front tube and inserting the front tube into the second housing, and
/B2/ pivoting the trim support around the front tube fitted into the second housing of the front mechanical interface until the rear tube is inserted into the first housing of the rear mechanical interface and mechanically locking the rear tube in the first housing via the locking system.

According to one embodiment of the second aspect, the assembly comprises in addition to the squab comprising the squab structure and the modular squab cushion, a backrest comprising a backrest structure and a backrest element, in particular a modular backrest cushion, removable from the backrest structure, and wherein the locking system comprises the backrest, in particular the backrest element and/or the backrest structure, the locking of the rear tube in the first housing being obtained by placing the backrest, in particular the backrest element and/or the backrest structure, in particular a modular backrest cushion, on the backrest structure, the backrest structure and/or the backrest element fixed to the backrest structure forming a stop preventing the rear tube from leaving the first housing, by preventing the modular squab cushion (CM) from pivoting around the front tube.

According to the present disclosure, a method for obtaining a seat assembly according to the present disclosure, in the assembled state, comprising the following steps:
providing a seat structure comprising a squab structure, in the assembled state, the squab structure comprising two lateral flanges spaced apart by a front transverse tube, and a rear transverse tube,
providing a modular squab cushion comprising, in the assembled state, at least one support comprising a mechanical interface system for attaching, to the squab structure, a padding resting on an upper surface of the support and a covering which covers the padding, the mechanical interface system comprising a rear mechanical interface, on a rear part of the support, comprising a first housing configured to house the rear tube, in a lockable manner around the rear tube by the locking system, and a front mechanical interface on a front part of the support, configured to house the front tube (23), in a second housing in a lockable manner,
assembling the modular cushion to the seat structure by implementing the following steps:
/A2/ placing the front mechanical interface opposite the front tube and inserting the front tube into the second housing, and
/B2/ pivoting the trim support around the front tube fitted into the second housing of the front mechanical interface until the rear tube is inserted into the first housing of the rear mechanical interface and mechanically locking the rear tube in the first housing via a locking system.

According to one embodiment, the assembly further comprises, in addition to the squab structure, a backrest, and wherein the locking system comprises the backrest, and wherein the locking of the rear tube in the first housing is obtained, by fastening the backrest to the squab structure in the assembled state, and in particular fastening a backrest structure to the squab structure and/or a backrest element such as a modular backrest cushion to the backrest structure previously fastened to the squab structure, the backrest, in particular the backrest structure and/or the backrest element, in particular the modular backrest cushion forming a stop preventing the rear tube from leaving the first housing, by preventing the modular squab cushion from pivoting about the front tube.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a view of a modular squab cushion in the disassembled state on the left and in the assembled state on the right, comprising a trim support, a padding and a cover.

FIG. 2 is a view of assembly kinematics for the modular cushion of FIG. 1, the kinematics comprising placing the front mechanical interface opposite the front tube, and pivoting the trim support around the front tube, which is then fitted into the second housing of the front mechanical interface, until the rear tube is inserted into the first housing of the front mechanical interface and the rear tube is mechanically locked in the first housing by a locking system.

FIG. 3 is a schematic top view of the squab structure, typically metal or composite, comprising two lateral flanges extending along a longitudinal X direction, and a front tube and a rear transverse tube respectively connecting the two lateral flanges, the front tube on the front of the squab structure and the rear tube on the rear of the squab structure.

FIG. 4 shows an embodiment of the trim support forming the base of the modular squab cushion, obtained by a single-piece plastic element, typically injection-molded, and noticeably features an overhanging, flexible portion on a rear portion of the support.

FIG. 5 is a view of an embodiment of a locking system, which involves fitting a backrest element, in particular a modular backrest cushion, and attaching it to a squab structure, after the rear tube has been inserted into the first housing, the backrest element then forming a stop for a rear portion of the modular squab cushion, preventing the modular squab cushion from pivoting in the opposite direction (opposite the direction of assembly) around the front tube received in the second housing, and thus preventing the rear tube from coming out of the first housing.

### DETAILED DESCRIPTION

Generally speaking, the present disclosure relates to a modular squab cushion CM, configured to be attached to a seat structure 2 having a squab structure comprising two lateral flanges 20 spaced apart by a front transverse tube 23 and a rear transverse tube 22. The squab structure is typically made of metal or composite.

The modular squab cushion comprises, in the assembled state:
a support S, also referred to as a trim support, forming a base comprising a mechanical interface system for fastening to the squab structure,
a padding MA resting on an upper surface of the support, and possibly but not necessarily,
a covering CF which covers the padding,

The padding MA provides comfortable seating. The padding can be based on polyurethane foam, typically obtained by molding, or on another material such as a 3-dimensional structure of continuous fibers, forming loops welded together, obtained by extruding thermoplastic fibers and calendering the fibers by two partially immersed members (rollers).

Notably, the mechanical interface system comprises:
a rear mechanical interface 16, on a rear portion of the support S, comprising a first, open housing LG1, configured to accommodate the rear tube 22 in a mechanically lockable manner by a locking system, in particular of the rear mechanical interface, i.e. internal to the modular cushion and/or external to the rear mechanical interface, or even external to the modular squab cushion, for example by fitting the backrest,
a front mechanical interface 17 on a front part of the support, comprising a second open housing LG2, configured to house the front tube 23, pivotably around the front tube 23,

Said mechanical interface system is configured to enable attachment of the modular squab cushion by the following steps, and as illustrated by way of non-limiting example in FIG. 2:

/A2/ placing the front mechanical interface 17 opposite the front tube 23 and inserting the front tube into the second housing LG2, and

/B2/ pivoting the trim support around the front tube 23 fitted into the second housing LG2 of the front mechanical interface 17 until the rear tube 22 is inserted into the first housing LG1 of the rear mechanical interface 16 and mechanically locking the rear tube 22 in the first housing LG1 via the locking system.

The first housing LG1 and/or the second housing LG2 can typically be U-shaped housings. The U-shaped housings may be continuous in the transverse direction Y, or result from a plurality of discontinuous sections.

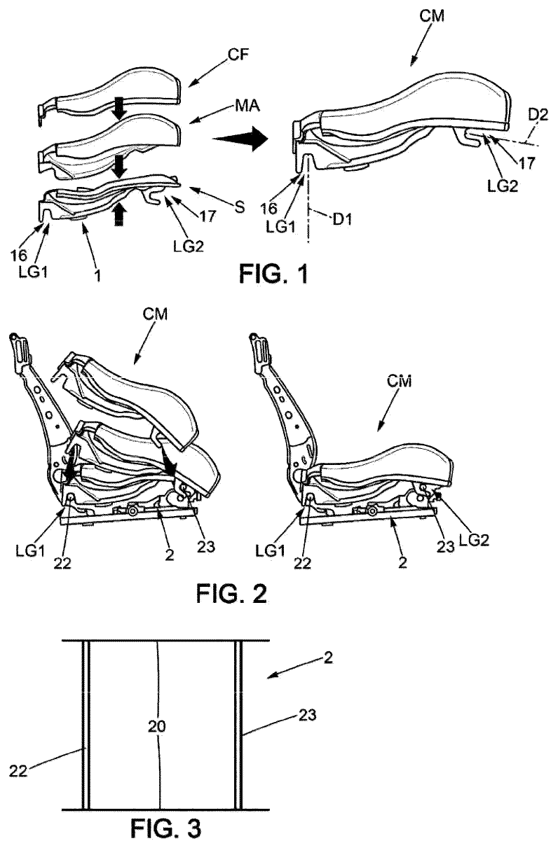

As shown in FIG. 1, the second housing LG2, typically located close to the front cross-member 10, opens out towards the front of the trim support 1, i.e. in the longitudinal direction X from a rear cross-member 11 of the support to a front cross-member 10 of the support.

In particular, the forward-opening second housing LG2 provides effective retention of the modular cushion in the event of a frontal crash: in the event of a frontal crash, the crash forces the front tube 23 to the back of the second housing LG2.

The first housing, LG1, opens out towards the underside of the support, typically in the vertical Z direction. In the event of a crash, the first housing LG1 helps to retain the modular squab cushion by bearing between a side wall of the first housing LG1 and the rear tube 22.

In the event of a crash, the restraint of the modular squab cushion (and of the occupant weighing on it) relative to the squab structure is distributed between the front tube 23 and the rear tube 22 of the squab structure. This increases crash resistance.

Generally speaking, the first housing LG1 comprises a first insertion direction D1 for the rear tube 22 and the second housing LG2 comprises a second insertion direction D2 for the front tube 23, the first insertion direction D1 and the second insertion direction D2 being inclined to one another at an angle of between 25° and 135°, for example between 45° and 90°.

Generally speaking, the locking system of the rear mechanical Interface 16 can be resiliently deformable, configured to allow resilient locking such that the locking of the rear tube 22 in the first housing LG1 is obtained at the end of travel during the pivoting of the modular cushion around the front tube in step /B/, by resilient deformation of the locking system of the rear mechanical Interface 16. To this end, the first housing LG1 can be resiliently deformable and comprise a groove entrance of smaller dimension than the cross-section of the rear tube 22, and a central portion housing the rear tube in locking position adjusted to the cross-section of the rear tube 22.

The locking system can also include a specific retaining member, such as a lug, which is fastened subsequently by the operator. In particular, it can be a locking system comprising one or more screws. The locking system may also include a latch.

As a further locking option (which may be combined with resilient locking), the rear tube 22 is locked in the first housing LG1 by positioning the backrest, in particular a modular backrest cushion, on a backrest structure and/or by positioning a backrest structure on the squab structure. Once the backrest element (or backrest structure) is attached to the backrest structure, the backrest element (or backrest structure) forms an upper stop, cooperating with a rear portion of the modular cushion, preventing the rear tube 22 from exiting the first housing LG1, by pivoting about the front tube 23.

The locking system may therefore be internal to the modular squab cushion, or external to the cushion, or comprise a part internal to the modular cushion and a part external to it.

The trim support S can be a plastic element 1 typically obtained by injection molding. The front and rear mechanical interfaces 16, 17 are preferably obtained from the material coming from the lining support, typically obtained during the molding of the trim support 1. In other words, the front and rear mechanical interface, including the first housing LG1 and the second housing LG2, form an integral plastic element with the body of the trim support S.

Generally speaking, the single-piece plastic element 1 may extend
from a front cross-member 10 to a rear cross-member 11 of the plastic element along a longitudinal direction X of the squab and,
from a first longitudinal member 12 to a second longitudinal member 12, along a transverse direction Y of the squab;

The seat trim support S thus comprises (or typically consists of) a single-piece plastic element 1 extending:
from the front cross-member 10 to a rear cross-member 11 of the plastic element along a longitudinal direction X of the squab and,
from the first longitudinal member 12 to the second longitudinal member 12, along a transverse direction Y of the squab.

The front cross-member 10 and rear cross-member 11 are substantially parallel in the transverse direction Y, and the first longitudinal member 12 and second longitudinal member 13 are substantially parallel in the longitudinal direction X.

The front and rear cross-members 10,11 and the first and second longitudinal members 12,13 extend end-to-end around the periphery of the plastic element 1, forming a support frame.

The support frame can optionally be configured to bear on the squab structure 2 of a vehicle seat, typically (but not necessarily) by bearing on the longitudinal members 12, 13 of the plastic element on flanges 20 of the squab structure, and by bearing on the front cross-member 10 and the rear cross-member 11, respectively, on a front tube 23 and on a rear tube 22 extending parallel to each other and connecting the two flanges 20.

The support may have a peripheral skirt JP, projecting downwards from the support.

In other words, the support frame can be supported solely on the structure's front cross-member 10 and rear cross-member 11, or simultaneously on both the front cross-member 10 and rear cross-member 11, as well as on the structure's flanges 20.

Said plastic element 1 may comprise an intermediate portion 14, extending along the transverse direction Y, the intermediate portion 14 connecting the first longitudinal member 12 to the second longitudinal member 13, the intermediate portion 14 arranged at an intermediate position between the front cross-member 10 and the rear cross-member 11 along the longitudinal direction X.

The intermediate position typically starts at a distance L14 from the front crossbar 10 on the first support half 1 in the longitudinal direction X, in particular at a distance L14 between ⅙ and ⅓ of the front edge of the front crossbar 10, for example at about ¼ of the distance from the front crossbar 10

According to one embodiment, the plastic element comprises a flexible suspension portion 15 extending continuously in the longitudinal direction X from the intermediate portion 14 to the rear cross-member 11 of the plastic element, connecting the intermediate portion 14 to the rear cross-member 11.

The suspension portion preferably extends discontinuously in the transverse direction Y between the first longitudinal member 12 and the second longitudinal member 1, the suspension portion 15 being separated, on the one hand, by a first lateral opening O1 arranged between the first longitudinal member 12 and the suspension portion 15, and on the other hand, by a second lateral opening O2 arranged between the suspension portion 15 and the second longitudinal member 13.

Said first lateral opening O1 and second lateral opening O2 separate the suspension portion 15 from the first longitudinal member 12 and second longitudinal member 13 along the length L15 of the suspension portion 15, preferably continuously along the entire length L15 (illustrated example) or possibly discontinuously along the length L15 due to local interruption(s) of the first opening O1 and second opening O2 along the length (according to a non-illustrated example).

The suspension portion forms a flexible plastic blade which extends in length L15 in the longitudinal direction X between the openings O1, O2, and in width 115 in the transverse direction Y from the first opening O1 to the second opening O2.

The function of the suspension portion 15 is to receive the seat occupant's buttocks, allowing the suspension portion to flex under load in the vertical direction Z.

The maximum flexibility in Z can be of the order of 30 mm, typically between 0.5 cm and 3 cm, for example between 1 cm and 3 cm for an average 75 kg dummy.

According to this embodiment, the trim support 1 can be advantageously devoid of metal suspension, and the suspension being obtained solely by the plastic element 1, in one piece.

The width 115 of the suspension portion 15 in the transverse direction Y, delimited between the first opening O1 and the second opening O2, may be less than 60% of the width 11 of the plastic element between the first longitudinal member 12 and the second longitudinal member 13 in the transverse direction, for example between 25% and 50% of the width 11 of the plastic element. The suspension portion 15 typically extends over a median portion of the support in the transverse direction Y, and only partially over the width of the trim support. This increases the flexibility under vertical stress of the suspension portion 15. The suspension portion extends over a rear portion of the support, close to the rear cross-member 11, relative to the front cross-member 10.

The function of the first opening O1 and the second opening O2 is thus to confer increased flexibility on the suspension portion 15, and also to contribute to an overall objective of reducing the material, and therefore the weight, of the plastic trim support.

The flexible blade of the suspension portion can extend in length L15, for example to a dimension of between 25% and 50% of the dimension of the support S in the longitudinal direction.

According to one embodiment, the flexible blade has all or some of the following features
a length L15 of between 200 cm and 300 cm, for example 270 cm,
a width 115 of between 180 cm and 250 cm, for example 220 cm,
a thickness e15 between 1 mm and 4 mm, for example 2.5 mm.

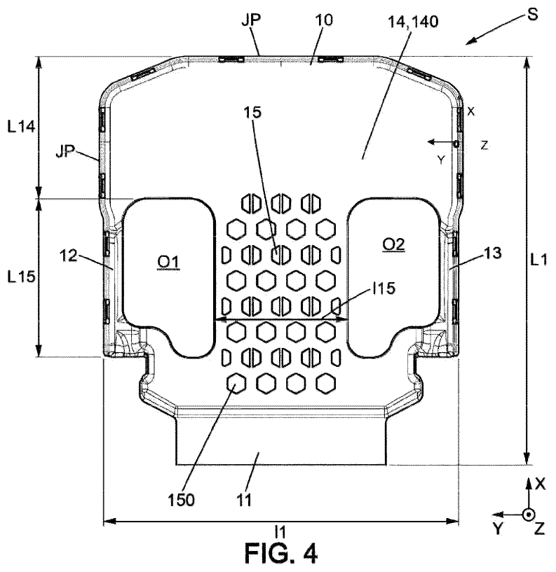

Generally speaking, and as illustrated by way of example in the view shown in FIG. 4, the trim support S may have some or all of the following features:
the upper face of the suspension portion can form a trough along the longitudinal direction X,
the suspension portion 15 can be arranged on the trim support, below the front portion of the support 1, the front portion comprising the front cross-member 10 and the intermediate portion 14.

The trim support profile can be raised in the longitudinal direction X, from the rear cross-member 11 to the front part of the trim support. This type of support profile prevents the seat occupant from being submarined under the seatbelt in the event of a frontal impact.

The suspension portion 15 can extend below the level of the first longitudinal member 12 and the second longitudinal member 13.

Generally speaking, and as shown by way of example in the figures, suspension portion 15 may comprise recesses 150 (blind or through) along a thickness of the suspension portion. The recesses 150 are distributed along a length dimension of the suspension portion 15, namely along the longitudinal direction X, and in particular over its entire length L15 or beyond, and/or along a dimension of the suspension portion 15 along the transverse direction Y and in particular over its entire width 115. The surface void ratio of the suspension portion 15 is between 10% and 80%, particularly in the presence of through recesses, and for example greater than 20%, or even greater than 30%, or even greater than 40%, or even greater than 50%.

The recesses contribute to the flexibility of the suspension portion in the vertical direction Z, and help to reduce the mass of the trim support 1.

According to an embodiment, the zone Z of the trim support delimited, along the longitudinal direction X, on the one hand, between the front cross-member 10 and the intermediate portion 14, and on the other hand, between the first longitudinal member 12 and the second longitudinal member 13 along the transverse direction Y, can advantageously be hollowed out.

In another embodiment, in addition to a plastic element 1 forming the front cross-member 10 and rear cross-member 11, as well as the first longitudinal member 12 and second longitudinal member 13, the trim support may comprise a housing on a rear portion of the plastic element, accommodating a typically metal suspension with spring wires.

The present disclosure relates, again according to this second aspect, to a seat assembly comprising the modular squab cushion and a squab structure 2 comprising two lateral flanges 20 braced by a rear tube 22 and a front tube 2 wherein,
the modular squab cushion CM comprising, in the assembled state:
   the trim support S,
   the padding MA resting on an upper surface of the trim support
   the cover CF covering the padding.

The squab structure, comprising the front and rear cross-members and flanges, can be made of metal or composite.

The mechanical interface system is configured to allow the attachment of the squab modular cushion by the following steps:

/A2/ placing the front mechanical interface 17 opposite the front tube 23 and inserting the front tube into the second housing LG2 and

/B2/ pivoting the trim support around the front tube 23 fitted into the second housing LG2 of the front mechanical interface 17 until the rear tube 22 is inserted into the first housing LG1 of the rear mechanical interface 16 and mechanically locking the rear tube 22 in the first housing LG1 via the locking system.

The support S is then fastened to the squab structure 2 in a position wherein the front tube 23 is housed in the second housing LG2 and the rear tube 22 is housed in the first housing LG1, locked in the first housing LG1 by the locking system The support S is then attached to the squab structure 2 in a position wherein:
the front cross-member 10 and the rear cross-member 11 of the plastic element are supported, respectively, on the front tube 23 and the rear tube 22 via the front mechanical interface 16 and the rear mechanical interface 17, and preferably, but not necessarily,
the first longitudinal member 12 and the second longitudinal member 13 of the plastic element rest on the two lateral flanges 20 respectively.

The squab structure 2 can typically be anchored to a vehicle floor, typically by a pair of slideways, allowing the squab structure to be moved forwards or backwards. Each slideway typically comprises a lower, typically female, section integral with the floor, and a male section, slidably mounted on the female section, integral with the squab structure

The present disclosure further relates to a method for obtaining a seat assembly, in the assembled state, comprising the following steps:
providing a seat structure 2 comprising a squab structure, in the assembled state, the squab structure comprising two lateral flanges 20 spaced apart by a front transverse tube 23, and a rear transverse tube 22,
providing a modular squab cushion CM comprising, in the assembled state, at least one support S comprising a mechanical interface system for attaching, to the squab structure, a padding MA resting on an upper surface of the base and a cover F which covers the padding, the mechanical interface system comprising a rear mechanical interface 16, on a rear part of the support S, comprising a first housing LG1 configured to house the rear tube 22, in a lockable manner around the rear tube 17, and a front mechanical interface on a front part of the support, configured to house the front tube 23, in a second housing LG2,
assembling the modular cushion to the seat structure by implementing the following steps:
/A2/ placing the front mechanical interface 17 opposite the front tube 23 and inserting the front tube into the second housing LG2, and
/B2/ pivoting the trim support around the front tube 23 fitted into the second housing LG2 of the front mechanical interface 17 until the rear tube 22 is inserted into the first housing LG1 of the rear mechanical interface 16 and mechanically locking the rear tube 22 in the first housing LG1 via a locking system.

The modular squab cushion implemented in the method is typically that previously described, according to the present disclosure.

According to one embodiment of the method, the assembly may comprise, in addition to the seat comprising the squab structure and the modular squab cushion, a backrest, in particular a backrest structure and/or a modular backrest cushion, the backrest configured to be removably attached to the squab structure. According to an advantageous embodiment, the locking system thus comprises the backrest, and in particular the backrest structure and/or a backrest element such as the modular backrest cushion.

The backrest structure can typically be articulated along a transverse axis on a rear portion of the squab structure. The backrest structure is typically made of metal or composite. The backrest element, in particular the modular cushion, typically comprises a padding, or even a support, and possibly a covering or cap, like the modular squab cushion.

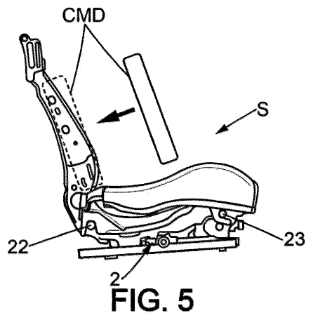

According to a first embodiment, the backrest structure, including the squab structure and the squab structure, is in the assembled state, prior to locking the modular squab cushion according to /B2/. In such a first embodiment, locking by the backrest is achieved by placing a backrest element on the backrest structure, and in particular a modular backrest cushion CMD, and as schematically shown in FIG. 5.

In particular, the rear tube 22 is locked in the first housing LG1 by securing the backrest element, in particular the modular backrest cushion, to the backrest structure, the backrest element, in particular the modular backrest cushion, forming an upper stop for the modular squab cushion, preventing the rear tube 22 from leaving the first housing LG1 by pivoting the modular squab cushion about the front tube 23.

In a second embodiment, only the squab structure is assembled prior to locking the modular squab cushion according to /B2/, i.e. the backrest structure is not assembled with the squab structure prior to locking the modular squab cushion. In such a second embodiment, locking by the backrest is achieved by fitting and securing the backrest structure to the squab structure, or even the backrest element.

The present disclosure further relates to a method for maintaining a seat, comprising disassembling the modular squab cushion CM from the seat structure, particularly without disassembling the seat structure from a floor of the vehicle by implementing the following steps:
/C/ unlocking the locking system, releasing the rear tube 22 from the front mechanical interface 16 and rotating the modular squab cushion CM around the front tube 23 housed in the first housing LG2 until the rear tube 22 is removed from the second housing LG1, and successively
/D/ removing the modular cushion by extracting the front tube 23 from the second housing LG2 of the front mechanical interface 17.

Generally speaking, the configurations of the first LG1 and second LG2 housings prevent the front tube 23 from coming out of the second housing LG2, until the rear tube has come out of the first housing LG1, by pivoting according to /C/.

The present disclosure relates to a modular squab cushion, configured to be attached to a seat structure having a squab structure, as well as a seat assembly comprising a squab and such a modular squab cushion according to the present disclosure, the squab structure having two lateral flanges spaced apart by a front transverse tube and a rear transverse tube.

The present disclosure further relates to a method for obtaining a seat cushion according to the present disclosure.

The present disclosure relates to the field of vehicle seats.

Some comparatives seat designs have the various components of the seat to be assembled at a site, typically according to just-in-time (JIT) manufacturing.

The structure of the comparatives seat comprises a seat structure typically made from metal which may comprise a squab structure and a backrest structure.

The comparatives seat structure may comprise:
two slideways, right and left, each comprising a lower profile, typically female, which is fixed relative to a floor, and an upper, male profile mounted slidably relative to the lower profile, typically along a direction X which can be the direction of advance of the vehicle,
a squab structure that comprises two flanges, right and left, spaced apart by tubes, and in particular a front tube spacing the flanges, on a front portion of the squab structure and a rear tube spacing the flanges on a rear portion of the squab structure, the front and rear tubes extending parallel, in a transverse direction,
a metal nose piece that connects front ends of the flanges and is shaped to form a support surface for the support of the squab cushion.

The height of the squab structure, namely the assembly that comprises the flanges and the nose piece, can typically be adjusted by a raising system which may comprise a pair of front, right and left, connecting rods connecting the front tube and the upper profiles of the right and left slideways, and a rear, right and left connecting rod gap connecting the rear tube and the upper profiles of the right and left slideways.

The squab of such a comparatives seat further comprises a suspension system typically with spring wires, connecting the nose piece to a rear part of the squab structure, but also a squab padding, typically expanded polyurethane foam, and a covering which covers the foam padding.

Depending on the options that may be chosen by the end user, various comfort equipment may be provided, such as in particular a resistive heating mat, a massage system, or a ventilation system, or even a sliding mechanism that is attached above the nose piece so as to be able to adjust the forward movement of a front part of the cushion, and relative to a fixed rear portion of the cushion.

A design of a seat is assembled, for example, manually, a large number of components on the final assembly site of the vehicle, which may not be economically optimal when the assembly site has a high labor cost.

For motor vehicles with superior finishes, comparatives seats may be equipped with additional functions, such as a heating, massage, or ventilation function.

These equipment items are integrated in the factory during the manufacture of the seat, then topped with cushions with their padding and coverings. The seat thus assembled is then attached to the floor of the vehicle.

In motor vehicles equipped with such comparatives seats, and when the seat is not provided with such comfort equipment from the start, the design of the seats does not allow disassembly of the seat within the vehicle itself, that is, without disassembling the seat from the floor of the vehicle, in order to improve the seat by adding an additional heating, ventilation, or massage function. Indeed, the addition of such equipment would have the vehicle seat to be removed in order to remove the coverings and the padding, this removal being necessary for such an addition.

However, other comparatives seat manufacturing which comprises the pre-assembly, typically on a site distinct from the final assembly site of the vehicle, of a module, and in particular a modular squab cushion. This modular cushion comprises, in the assembled state, a base, padding and a covering. It can typically be transported to the final assembly site for its assembly to the structure.

A composite nose piece of the base is articulated to a base body, about a transverse axis of the seat, the nose piece comprising a set of hooks attached to the front tube. The nose piece and the base body are two unitary parts, typically injection-molded, using two injection molds. The base body supports a spring wire suspension. In the event of a frontal impact, the possible rotation between the nose piece and the base participates in dissipating the energy during the impact, and favorably supports the hips in order to avoid submarining.

This solution therefore relies on the possibility of sliding between the base body and the squab structure in the event of a crash, so as to generate relative rotation between the nose piece and the base body, i.e. the forces absorbed in the event of a crash are reflected solely on the front tube of the squab structure.

According to the present disclosure, such a modular cushion solution is improved in the event of a frontal crash, but it is an expensive solution, in particular in that it uses three separate parts (i.e. the nose piece, the base body, articulated to the nose piece, and the metal suspension) to form the base.

The present disclosure improves all or part of the situation.

According to a first aspect, the present disclosure relates to a modular squab cushion, configured to be attached to a squab structure having a squab structure comprising two lateral flanges spaced apart by a front transverse tube and a rear transverse tube,

the modular squab cushion comprising, in the assembled state:
a support forming a base comprising a mechanical interface system for attachment to the squab structure,
a padding resting on an upper surface of the support, and optionally
a covering which covers the padding, and wherein the mechanical interface system comprises:
a rear mechanical interface, on a rear portion of the support, comprising a first, open housing, configured to accommodate the rear tube in a mechanically lockable manner by a locking system, in particular of the rear mechanical interface and/or external to the rear mechanical interface, or even external to the modular squab cushion
a front mechanical interface on a front part of the support, comprising a second open housing, configured to house the front tube, pivotably around the front tube, and wherein the mechanical interface system is configured to allow the attachment of the modular squab cushion by the following steps:
/A2/ placing the front mechanical interface opposite the front tube and inserting the front tube into the second housing, and
/B2/ pivoting the trim support around the front tube fitted into the second housing of the front mechanical interface until the rear tube is inserted into the first housing of the rear mechanical interface and mechanically locking the rear tube in the first housing via the locking system.

The features disclosed in the following paragraphs can optionally be implemented independently of one another or in combination with one another:
The first housing and/or the second housing are U-shaped housings;
the second, front housing opens out towards the front of the trim support, while the first housing opens out towards the underside of the trim support;
the first housing comprises a first insertion direction D1 for the rear tube and the second housing comprises a second insertion direction D2 for the front tube, the first insertion direction D1 and the second insertion direction D2 being inclined to one another at an angle of between 25° and 135°, for example between 45° and 90°;
the locking system of the rear mechanical interface is resiliently deformable, configured to allow resilient locking so that the locking of the rear tube in the first housing is obtained, at the end of stroke during pivoting carried out in step/B/of the modular cushion about the front tube, by resilient deformation of the locking system of the rear mechanical interface, preferably the first housing comprising a groove entrance of smaller dimension than the section of the rear tube, and a central portion housing the rear tube in locking position adjusted to the section of the rear tube;
the support is a plastic element obtained by injection molding, and wherein preferably the front and rear mechanical interfaces are obtained via the material from the support, typically during the molding of the support and wherein the single-piece plastic element extends
   from a front cross-member to a rear cross-member of the plastic element along a longitudinal direction X of the squab and,
   from a first longitudinal member to a second longitudinal member, along a transverse direction Y of the squab;

The present disclosure further relates, according to a second aspect, to a seat assembly comprising a modular squab cushion according to the present disclosure and a squab structure comprising two lateral flanges braced by a rear tube and a front tube wherein, the modular squab cushion comprising, in the assembled state:
the support,
the padding resting on an upper surface of the support,
the covering covering the padding

and wherein the mechanical interface system is configured to allow the attachment of the modular squab cushion by the following steps:
/A2/ placing the front mechanical interface opposite the front tube and inserting the front tube into the second housing, and
/B2/ pivoting the trim support around the front tube fitted into the second housing of the front mechanical interface until the rear tube is inserted into the first housing of the rear mechanical interface and mechanically locking the rear tube in the first housing via the locking system.

According to one embodiment of the second aspect, the assembly comprises in addition to the squab comprising the squab structure and the modular squab cushion, a backrest comprising a backrest structure and a backrest element, in particular a modular backrest cushion, removable from the backrest structure, and wherein the locking system comprises the backrest, in particular the backrest element and/or the backrest structure, the locking of the rear tube in the first housing being obtained by placing the backrest, in particular the backrest element and/or the backrest structure, in particular a modular backrest cushion, on the backrest structure, the backrest structure and/or the backrest element fixed to the backrest structure forming a stop preventing the rear tube from leaving the first housing, by preventing the modular squab cushion (CM) from pivoting around the front tube.

The present disclosure further relates, according to a third aspect, to a method for obtaining a seat assembly according to the present disclosure, in the assembled state, comprising the following steps:
providing a seat structure comprising a squab structure, in the assembled state, the squab structure comprising two lateral flanges spaced apart by a front transverse tube, and a rear transverse tube,
providing a modular squab cushion comprising, in the assembled state, at least one support comprising a mechanical interface system for attaching, to the squab structure, a padding resting on an upper surface of the support and a covering which covers the padding, the mechanical interface system comprising a rear mechanical interface, on a rear part of the support, comprising a first housing configured to house the rear tube, in a lockable manner around the rear tube by the locking system, and a front mechanical interface on a front part of the support, configured to house the front tube (23), in a second housing in a lockable manner,
assembling the modular cushion to the seat structure by implementing the following steps:
/A2/ placing the front mechanical interface opposite the front tube and inserting the front tube into the second housing, and
/B2/ pivoting the trim support around the front tube fitted into the second housing of the front mechanical interface until the rear tube is inserted into the first housing of the rear mechanical interface and mechanically locking the rear tube in the first housing via a locking system.

According to one embodiment, the assembly further comprises, in addition to the squab structure, a backrest, and wherein the locking system comprises the backrest, and wherein the locking of the rear tube in the first housing is obtained, by fastening the backrest to the squab structure in the assembled state, and in particular fastening a backrest structure to the squab structure and/or a backrest element such as a modular backrest cushion to the backrest structure previously fastened to the squab structure, the backrest, in particular the backrest structure and/or the backrest element, in particular the modular backrest cushion forming a stop preventing the rear tube from leaving the first housing, by preventing the modular squab cushion from pivoting about the front tube.

The present disclosure relates to a modular squab cushion (CM), configured to be attached to a seat structure (2) having a squab structure comprising two lateral flanges (20) spaced apart by a front transverse tube (23) and a rear transverse tube (22),
the modular squab cushion comprising, in the assembled state:
   a support,
   a padding resting on an upper surface of the support,
   a covering which covers the padding,
and wherein the mechanical interface system comprises:
   a rear mechanical interface (16) on a rear portion of the base (10), comprising a first open housing (LG1), configured to house the rear tube (22), in a manner mechanically lockable by a locking system (22),
   a front mechanical interface (17) on a front part of the support, comprising a second open housing (LG2), configured to house the front tube (23) pivotably around the front tube (23).

### LIST OF REFERENCE SIGNS

1. Plastic element,
10. Front cross-member,
11. Rear cross-member,
12. First longitudinal member,
13. Second longitudinal member,
14. Intermediate portion,
140. Intermediate cross-member,
15. Suspension portion,
150. Recesses,
O1. First opening (between the first longitudinal member and the suspension portion)
O2. Second opening (between the second longitudinal member and the suspension portion)
2. Squab structure,
20. Lateral flanges,
22. Rear tube,
23. Front tube
16. Rear mechanical Interface,
LG1. First housing (for the rear tube 22),
17. Front mechanical Interface,
LG2. Second housing (for the front tube 23),
CM. Modular squab cushion,
MA. Cushion,
CF. Covering,
D1, D2. First and second insertion directions,
S. Support.

1. A modular squab cushion, configured to be attached to a seat structure having a squab structure comprising two lateral flanges spaced apart by a front transverse tube and a rear transverse tube,
the modular squab cushion comprising, in the assembled state:
a support forming a base comprising a mechanical interface system for attachment to the squab structure,
the padding resting on an upper surface of the support,
and wherein the mechanical interface system comprises:
a rear mechanical interface, on a rear portion of the support, comprising a first, open housing, configured to accommodate the rear tube in a mechanically lockable manner by a locking system, in particular of the rear mechanical interface and/or external to the rear mechanical interface, or even external to the modular squab cushion,
a front mechanical interface on a front part of the support, comprising a second open housing, configured to house the front tube, pivotably around the front tube,
and wherein the mechanical interface system is configured to allow the attachment of the modular squab cushion by the following steps:
/A2/ placing the front mechanical interface opposite the front tube and inserting the front tube into the second housing and
/B2/ pivoting the trim support around the front tube fitted into the second housing of the front mechanical interface until the rear tube is inserted into the first housing of the rear mechanical interface and mechanically locking the rear tube in the first housing via the locking system.

2. The modular squab cushion of claim 1, wherein the first housing and/or the second housing are U-shaped housings.

3. The modular squab cushion of claim 1, wherein the second, front housing opens out towards the front of the trim support and the first housing opens out towards the underside of the trim support.

4. The modular squab cushion of claim 3, wherein the first housing comprises a first insertion direction for the rear tube and the second housing comprises a second insertion direction for the front tube, the first insertion direction and the second insertion direction being inclined to one another at an angle of between 25° and 135°, for example between 45° and 90°.

5. The modular squab cushion of claim 1, wherein the locking system of the rear mechanical interface is resiliently deformable, configured to allow resilient locking so that the locking of the rear tube in the first housing is obtained, at the end of stroke during pivoting carried out in step /B/ of the modular cushion about the front tube, by resilient deformation of the locking system of the rear mechanical interface, preferably the first housing comprising a groove entrance of smaller dimension than the section of the rear tube, and a central portion housing the rear tube in locking position adjusted to the section of the rear tube.

6. The modular squab cushion of claim 1, wherein the support is a plastic element obtained by injection molding, and wherein preferably the front and rear mechanical interfaces are obtained by the material coming from the support, typically during the molding of the support and wherein the single-piece plastic element extends
from a front cross-member to a rear cross-member of the plastic element along a longitudinal direction X of the squab and,
from a first longitudinal member to a second longitudinal member, along a transverse direction Y of the squab.

7. A seat assembly comprising the modular squab cushion of claim 1 and a squab structure comprising two lateral flanges spaced apart by a rear tube and a front tube, and wherein,
the modular squab cushion comprising, in the assembled state:
the support,
the padding resting on an upper surface of the support,
the cover covering the padding
and wherein the mechanical interface system is configured to allow the attachment of the modular squab cushion by the following steps:
/A2/ placing the front mechanical interface opposite the front tube and inserting the front tube into the second housing and
/B2/ pivoting the trim support around the front tube fitted into the second housing of the front mechanical interface until the rear tube is inserted into the first housing of the rear mechanical interface and mechanically locking the rear tube in the first housing via the locking system.

8. The seat assembly of claim 7, comprising in addition to the squab including the squab structure and the modular squab cushion, a backrest comprising a backrest structure and a backrest element, in particular a modular backrest cushion, and wherein the locking system comprises the backrest, in particular the backrest element and/or the backrest structure, the locking of the rear tube in the first housing being obtained by placing the backrest, in particular the backrest element and/or the backrest structure, in particular a modular backrest cushion, on the backrest structure, the backrest structure and/or the backrest element fixed to the backrest structure forming a stop preventing the rear tube from leaving the first housing, by preventing the modular squab cushion from pivoting around the front tube.

9. A method for obtaining the seat assembly of claim 7, in the assembled comprising the following steps:
providing a seat structure comprising a squab structure, in the assembled state, the squab structure comprising two lateral flanges spaced apart by a front transverse tube, and a rear transverse tube,
providing a modular squab cushion comprising, in the assembled state, at least one support comprising a mechanical interface system for attaching, to the squab structure, a padding resting on an upper surface of the base and a cover which covers the padding, the mechanical interface system comprising a rear mechanical interface, on a rear part of the support, comprising a first housing configured to house the rear tube, in a lockable manner around the rear tube, and a front mechanical interface on a front part of the support, configured to house the front tube, in a second housing,
assembling the modular cushion to the seat structure by implementing the following steps:
/A2/ placing the front mechanical interface opposite the front tube and inserting the front tube into the second housing and
/B2/ pivoting the trim support around the front tube fitted into the second housing of the front mechanical interface until the rear tube is inserted into the first housing of the rear mechanical interface and mechanically locking the rear tube in the first housing via a locking system.

10. The method according to claim 9, wherein the assembly further comprises, in addition to the squab structure, a backrest, and wherein the locking system comprises the backrest, and wherein the locking of the rear tube in the first housing is obtained, by fastening the backrest to the squab structure in the assembled state, and in particular fastening a backrest structure to the squab structure and/or fastening a backrest element such as a modular backrest cushion to the backrest structure previously fastened to the squab structure, the backrest, in particular the backrest structure and/or the backrest element, in particular the modular backrest cushion forming a stop preventing the rear tube from leaving the first housing, by preventing the modular squab cushion from pivoting about the front tube.
